(19) United States
(12) Patent Application Publication
(10) Pub. No.: US 2008/0141584 A1
(43) Pub. Date: Jun. 19, 2008

(54) Methods for Using a Catalyst Preburner in Fuel Processing Applications

(75) Inventors: Lixin You, Sugar Land, TX (US); Daniel G. Casey, Kingwood, TX (US); Kevin H. Nguyen, Missouri City, TX (US)

Correspondence Address: CHEVRON SERVICES COMPANY;LAW, INTELLECTUAL PROPERTY GROUP, P.O. BOX 4368, HOUSTON, TX, 77210-4368, US

(73) Assignee: Texaco Inc., San Ramon, CA (US)

(21) Appl. No.: 11/610,975

(22) Filed: Dec. 14, 2006

(51) Int. Cl. C10L 9/10

(52) U.S. Cl. 44/603

(57) ABSTRACT

Methods of using a catalyst preburner upstream of a catalyst burner, such as an anode tailgas oxidizer (ATO), in fuel processing applications. The methods prepare a hydrogen containing gas mixture which can be effectively combusted in a single ATO. The catalyst preburner will convert raw fuels into a gas mixture including hydrogen. This hydrogen containing gas mixture then mixes with the required air flow and anode tailgas and off-gas from a pressure swing adsorption unit before being introduced into the catalyst burner. The methods address the start-ups needs of an ATO as well as the requirement that an ATO be able to burn both liquid and gas fuels in a single unit.

### FIELD OF THE INVENTION

The present invention relates generally to methods of using a catalyst preburner upstream of a catalyst burner, such as an anode tailgas oxidizer, in fuel processing applications.

### BACKGROUND OF THE INVENTION

Fuel cells provide electricity from chemical oxidation-reduction reactions and possess significant advantages over other forms of power generation in terms of cleanliness and efficiency. Typically, fuel cells employ hydrogen as the fuel and oxygen as the oxidizing agent. The power generation is proportional to the consumption rate of the reactants.

A significant disadvantage which inhibits the wider use of fuel cells is the lack of a widespread hydrogen infrastructure. Hydrogen has a relatively low volumetric energy density and is more difficult to store and transport than the hydrocarbon fuels currently used in most power generation systems. One way to overcome this difficulty is the use of reformers to convert the hydrocarbons to a hydrogen rich gas stream which can be used as a feed for fuel cells.

Hydrocarbon-based fuels, such as natural gas, LPG, gasoline, and diesel, require conversion processes to be used as fuel sources for most fuel cells. Current art uses multi-step processes combining an initial conversion process with several clean-up processes. The initial process is most often steam reforming (SR), autothermal reforming (ATR), catalytic partial oxidation (CPOX), or non-catalytic partial oxidation (POX). The cleanup processes are usually comprised of a combination of desulfurization, high temperature water-gas shift, low temperature water-gas shift, selective CO oxidation, or selective CO methanation. Alternative processes include hydrogen selective membrane reactors and filters.

A catalytic burner, such as an anode tailgas oxidizer (ATO), is essential for the operation of fuel processors and fuel cells. A single ATO must have the capability to effectively burn off-gas from fuel cells and off-gas from a pressure swing adsorption unit. In addition, a single ATO must have the capability to effectively burn natural gas, liquid hydrocarbons, and alcohols. Further, a single ATO must have liquid fuels combustion capability for startup and supplemental fuels. While catalysts burners, such as an ATO, are advantageous over conventional burners, there are issues associated with the operation of an ATO in fuel processing applications.

One issue associated with an ATO includes the difficult start-up of a natural gas catalyst burner. Specifically, the start-up of a natural gas catalyst burner requires a large amount of preheated air or electrical power input. In fuel processing applications, natural gas and/or air must to be preheated to a temperature higher than the natural gas light-off temperature (approximately 300° C.) to be oxidized in the ATO. Further, very high air flow (an oxygen to carbon ratio of approximately 7) is needed to control the catalyst bed temperature which requires approximately 33.3 moles of air for 1 mole of natural gas. An electrical heater must be used to keep the catalyst bed hot or a large heat exchanger must be used to preheat the natural gas and/or air. Both of these solutions present several design and operational problems.

Another issue associated with an ATO includes the requirement to burn both liquid and gas fuels in a single unit. In fuel processing applications the ATO must have the capability to burn a variety of fuels—including both liquid and gas fuels—in a single unit. This requirement presents a design challenge.

The present invention addresses the start-ups needs of an ATO as well as the requirement that an ATO be able to burn both liquid and gas fuels in a single unit.

### SUMMARY OF THE INVENTION

The present invention provides methods of using a catalyst preburner upstream of a catalyst burner, such as an anode tailgas oxidizer (ATO), in fuel processing applications. The methods of the present invention prepare a hydrogen containing gas mixture which can be effectively combusted in a single ATO. The catalyst preburner will convert raw fuels into a gas mixture including hydrogen. This hydrogen containing gas mixture then mixes with the required air flow before being introduced into the catalyst burner.

When utilizing a preburner as in the present invention, the heating requirement for a natural gas catalyst burner is reduced. First, the heating requirement of a catalyst preburner is much less than that for a regular catalyst burner. Second, since hydrogen can light-off at about 40° C., no heating of the air is required in the following catalyst burner. Thus, for natural gas fuel, the heating requirement is significantly reduced.

Further, when utilizing a preburner as in the present invention, the fuel conversion for a natural gas catalyst burner is increased. In the catalyst preburner, using an oxygen to carbon ratio of less than 1 results in some hydrogen being present in the gas mixture from partial oxidation. Because hydrogen is easy to light-off in the following catalyst burner, the total fuel conversion will be high.

In addition, when utilizing a preburner as in the present invention, there is no need for a dual fuel catalyst burner. If a liquid fuel mixture is used, the catalyst preburner only needs to have the capability for liquid oxidation. The catalyst preburner does not need to burn gas and the following catalyst burner does not need to burn liquid fuels—the catalyst burner is only required to burn gas fuels. Therefore, the design challenge for liquid fuels is solved.

Finally, the use of a preburner as in the present invention provides an additional benefit—the resulting hydrogen from the preburner can be mixed with air inside the second reaction zone eliminating the formation of an explosive mixture outside of the reaction zone.

### BRIEF DESCRIPTION OF THE DRAWINGS

The description is presented with reference to the accompanying drawings in which:

FIG. 1 depicts a simple process flow diagram for a fuel processor.

FIG. 2 illustrates one embodiment of a compact fuel processor.

FIG. 3 illustrates one embodiment of a catalyst preburner upstream of an anode tailgas oxidizer for fuel processing applications.

### DESCRIPTION OF ILLUSTRATIVE EMBODIMENTS

An anode tailgas oxidizer (ATO) is essential for the operation of fuel processors and fuel cells. The present invention provides methods of using a catalyst preburner upstream of an ATO in fuel processing applications.

A fuel processor is generally an apparatus for converting hydrocarbon fuel into a hydrogen rich gas. In one embodiment, the compact fuel processor described herein produces a hydrogen rich gas stream from a hydrocarbon fuel for use in fuel cells. However, other possible uses of the methods of the present invention are contemplated, including any use wherein a hydrogen rich stream is desired. Accordingly, while the invention is described herein as being used in conjunction with a fuel cell, the scope of the invention is not limited to such use. Each of the illustrative embodiments describe a fuel processor or a process for using a fuel processor with the hydrocarbon fuel feed being directed through the fuel processor.

The hydrocarbon fuel for the fuel processor may be liquid or gas at ambient conditions as long as it can be vaporized. As used herein the term “hydrocarbon” includes organic compounds having C—H bonds which are capable of producing hydrogen from a partial oxidation or steam reforming reaction. The presence of atoms other than carbon and hydrogen in the molecular structure of the compound is not excluded. Thus, suitable fuels for the fuel processor include, but are not limited to hydrocarbon fuels such as natural gas, methane, ethane, propane, butane, naphtha, gasoline, and diesel fuel, and alcohols such as methanol, ethanol, propanol, and the like.

The fuel processor feeds include hydrocarbon fuel, oxygen, and water. The oxygen can be in the form of air, enriched air, or substantially pure oxygen. The water can be introduced as a liquid or vapor. The composition percentages of the feed components are determined by the desired operating conditions, as discussed below.

The fuel processor effluent stream includes hydrogen and carbon dioxide and can also include some water, unconverted hydrocarbons, carbon monoxide, impurities (e.g. hydrogen sulfide and ammonia) and inert components (e.g., nitrogen and argon, especially if air was a component of the feed stream).

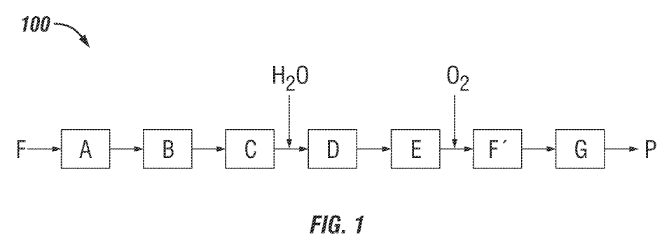

With reference to FIG. 1, FIG. 1 depicts a simple process flow diagram for a fuel processor illustrating the process steps included in converting a hydrocarbon fuel into a hydrogen rich gas. One of skill in the art should appreciate that a certain amount of progressive order is needed in the flow of the reactants through the reactors disclosed herein.

Process step A is an autothermal reforming process in which two reactions, partial oxidation (formula I, below) and optionally also steam reforming (formula II, below), are combined to convert the feed stream F into a synthesis gas containing hydrogen and carbon monoxide. Formulas I and II are exemplary reaction formulas wherein methane is considered as the hydrocarbon:

CH₄+½O₂->2H₂+CO (I)

CH₄+H₂O->3H₂+CO (II)

The partial oxidation reaction occurs very quickly to the complete conversion of oxygen added and produces heat: The steam reforming reaction occurs slower and consumes heat. A higher concentration of oxygen in the feed stream favors partial oxidation whereas a higher concentration of water vapor favors steam reforming. Therefore, the ratios of oxygen to hydrocarbon and water to hydrocarbon become characterizing parameters. These ratios affect the operating temperature and hydrogen yield.

The operating temperature of the autothermal reforming step can range from about 550° C. to about 900° C., depending on the feed conditions and the catalyst. The invention uses a catalyst bed of a partial oxidation catalyst with or without a steam reforming catalyst. The catalyst may be in any form including pellets, spheres, extrudate, monoliths, and the like. Partial oxidation catalysts should be well known to those with skill in the art and are often comprised of noble metals such as platinum, palladium, rhodium, and/or ruthenium on an alumina washcoat on a monolith, extrudate, pellet or other support. Non-noble metals such as nickel or cobalt have been used. Other washcoats such as titania, zirconia, silica, and magnesia have been cited in the literature. Many additional materials such as lanthanum, cerium, and potassium have been cited in the literature as “promoters” that improve the performance of the partial oxidation catalyst.

Steam reforming catalysts should be known to those with skill in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium.

Process step B is a cooling step for cooling the synthesis gas stream from process step A to a temperature of from about 200° C. to about 600° C., preferably from about 300° C. to about 500° C., and more preferably from about 375° C. to about 425° C., to optimize the temperature of the synthesis gas effluent for the next step. This cooling may be achieved with heat sinks, heat pipes or heat exchangers depending upon the design specifications and the need to recover/recycle the heat content of the gas stream. One illustrative embodiment for step B is the use of a heat exchanger utilizing feed stream F as the coolant circulated through the heat exchanger. The heat exchanger can be of any suitable construction known to those with skill in the art including shell and tube, plate, spiral, etc. Alternatively, or in addition thereto, cooling step B may be accomplished by injecting additional feed components such as fuel, air or water. Water is preferred because of its ability to absorb a large amount of heat as it is vaporized to steam. The amounts of added components depend upon the degree of cooling desired and are readily determined by those with skill in the art.

Process step C is a purifying step. One of the main impurities of the hydrocarbon stream is sulfur, which is converted by the autothermal reforming step A to hydrogen sulfide. The processing core used in process step C preferably includes zinc oxide and/or other material capable of absorbing and converting hydrogen sulfide, and may include a support (e.g., monolith, extrudate, pellet etc.). Desulfurization is accomplished by converting the hydrogen sulfide to water in accordance with the following reaction formula III:

H₂S+ZnO->H₂O+ZnS (III)

Other impurities such as chlorides can also be removed. The reaction is preferably carried out at a temperature of from about 300° C. to about 500° C., and more preferably from about 375° C. to about 425° C. Zinc oxide is an effective hydrogen sulfide absorbent over a wide range of temperatures from about 25° C. to about 700° C. and affords great flexibility for optimizing the sequence of processing steps by appropriate selection of operating temperature.

The effluent stream may then be sent to a mixing step D in which water is optionally added to the gas stream. The addition of water lowers the temperature of the reactant stream as it vaporizes and supplies more water for the water gas shift reaction of process step E (discussed below). The water vapor and other effluent stream components are mixed by being passed through a processing core of inert materials such as ceramic beads or other similar materials that effectively mix and/or assist in the vaporization of the water. Alternatively, any additional water can be introduced with feed, and the mixing step can be repositioned to provide better mixing of the oxidant gas in the CO oxidation step G disclosed below.

Process step E is a water gas shift reaction that converts carbon monoxide to carbon dioxide in accordance with formula IV:

H₂O+CO->H₂+CO₂ (IV)

This is an important step because carbon monoxide, in addition to being highly toxic to humans, is a poison to fuel cells. The concentration of carbon monoxide should preferably be lowered to a level that can be tolerated by fuel cells, typically below 50 ppm. Generally, the water gas shift reaction can take place at temperatures of from 150° C. to 600° C. depending on the catalyst used. Under such conditions, most of the carbon monoxide in the gas stream is converted in this step.

Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like.

High temperature shift catalysts are preferably operated at temperatures ranging from about 3000 to about 600° C. and can include transition metal oxides such as ferric oxide or chromic oxide, and optionally including a promoter such as copper or iron suicide. Also included, as high temperature shift catalysts are supported noble metals such as supported platinum, palladium and/or other platinum group members.

The processing core utilized to carry out this step can include a packed bed of high temperature or low temperature shift catalyst such as described above, or a combination of both high temperature and low temperature shift catalysts. The process should be operated at any temperature suitable for the water gas shift reaction, preferably at a temperature of from 150° C. to about 400° C. depending on the type of catalyst used. Optionally, a cooling element such as a cooling coil may be disposed in the processing core of the shift reactor to lower the reaction temperature within the packed bed of catalyst. Lower temperatures favor the conversion of carbon monoxide to carbon dioxide. Also, a purification processing step C can be performed between high and low shift conversions by providing separate steps for high temperature and low temperature shift with a desulfurization module between the high and low temperature shift steps.

Process step F′ is a cooling step performed in one embodiment by a heat exchanger. The heat exchanger can be of any suitable construction including shell and tube, plate, spiral, etc. Alternatively a heat pipe or other form of heat sink may be utilized. The goal of the heat exchanger is to reduce the temperature of the gas stream to produce an effluent having a temperature preferably in the range of from about 90° C. to about 150° C.

Oxygen is added to the process in step F′. The oxygen is consumed by the reactions of process step G described below. The oxygen can be in the form of air, enriched air, or substantially pure oxygen. The heat exchanger may by design provide mixing of the air with the hydrogen rich gas. Alternatively, the embodiment of process step D may be used to perform the mixing.

Process step G is an oxidation step wherein almost all of the remaining carbon monoxide in the effluent stream is converted to carbon dioxide. The processing is carried out in the presence of a catalyst for the oxidation of carbon monoxide and may be in any suitable form, such as pellets, spheres, monolith, etc. Oxidation catalysts for carbon monoxide are known and typically include noble metals (e.g., platinum, palladium) and/or transition metals (e.g., iron, chromium, manganese), and/or compounds of noble or transition metals, particularly oxides. A preferred oxidation catalyst is platinum on an alumina washcoat. The washcoat may be applied to a monolith, extrudate, pellet or other support. Additional materials such as cerium or lanthanum may be added to improve performance. Many other formulations have been cited in the literature with some practitioners claiming superior performance from rhodium or alumina catalysts. Ruthenium, palladium, gold, and other materials have been cited in the literature as being active for this use.

Two reactions occur in process step G: the desired oxidation of carbon monoxide (formula V) and the undesired oxidation of hydrogen (formula VI) as follows:

CO+½O₂->CO₂ (V)

H₂+½O₂->H₂O (VI)

The preferential oxidation of carbon monoxide is favored by low temperatures. Since both reactions produce heat it may be advantageous to optionally include a cooling element such as a cooling coil disposed within the process. The operating temperature of the process is preferably kept in the range of from about 90° C. to about 150° C. Process step G preferably reduces the carbon monoxide level to less than 50 ppm, which is a suitable level for use in fuel cells, but one of skill in the art should appreciate that the present invention can be adapted to produce a hydrogen rich product with higher and lower levels of carbon monoxide.

The effluent exiting the fuel processor is a hydrogen rich gas containing carbon dioxide and other constituents which may be present such as water, inert components (e.g., nitrogen, argon), residual hydrocarbon, etc. Product gas may be used as the feed for a fuel cell or for other applications where a hydrogen rich feed stream is desired. Optionally, product gas may be sent on to further processing, for example, to remove the carbon dioxide, water or other components.

Fuel processor 100 contains a series of process units for carrying out the general process as described in FIG. 1. It is intended that the process units may be used in numerous configurations as is readily apparent to one skilled in the art. Furthermore, the fuel processor described herein is adaptable for use in conjunction with a fuel cell such that the hydrogen rich product gas of the fuel processor described herein is supplied directly to a fuel cell as a feed stream.

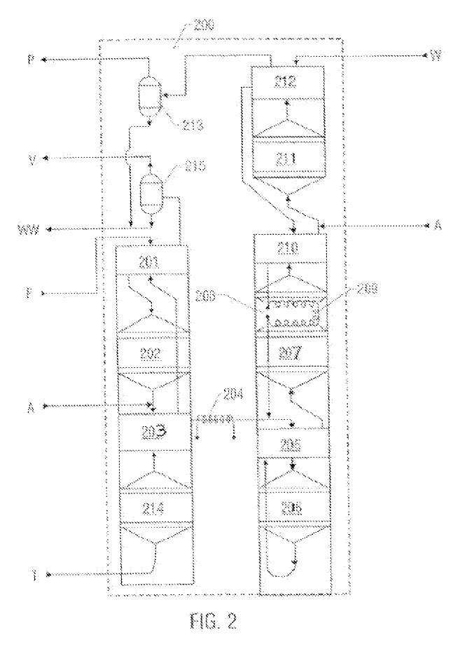

With reference to FIG. 2, FIG. 2 illustrates one embodiment of a compact fuel processor. Fuel processor 200 as shown in FIG. 2 is similar to the process diagrammatically illustrated in FIG. 1 and described above. Hydrocarbon fuel feed stream F is introduced to the fuel processor and hydrogen rich product gas P is drawn off. Fuel processor 200 includes several process units that each perform a separate operational function and is generally configured as shown in FIG. 2. In this illustrative embodiment, the hydrocarbon fuel F enters the first compartment into spiral exchanger 201, which preheats the feed F against fuel cell tail gas T (enters fuel processor 200 at ATO 214). Because of the multiple exothermic reactions that take place within the fuel processor, one of skill in the art should appreciate that several other heat integration opportunities are also plausible in this service. This preheated feed then enters desulfurization reactor 202 through a concentric diffuser for near-perfect flow distribution and low pressure drop at the reactor inlet. Reactor 202 contains a desulfurizing catalyst and operates as described in process step C of FIG. 1. (Note that this step does not accord with the order of process steps as presented in FIG. 1. This is a prime example of the liberty that one of skill in the art may exercise in optimizing the process configuration in order to process various hydrocarbon fuel feeds and/or produce a more pure product.) Desulfurized fuel from reactor 202 is then collected through a concentric diffuser and mixed with air A, with the mixture being routed to exchanger 203. In this illustrative embodiment, exchanger 203 is a spiral exchanger that heats this mixed fuel/air stream against fuel cell tail gas T (enters fuel processor 200 at ATO 214).

The preheated fuel/air mixture then enters the second compartment with the preheat temperature maintained or increased by electric coil heater 204 located between the two compartments. The preheated fuel-air mixture enters spiral exchanger 205, which preheats the stream to autothermal reforming reaction temperature against the autothermal reformer (ATR) 206 effluent stream. Preheated water (enters fuel processor 200 at exchanger 212) is mixed with the preheated fuel-air stream prior to entering exchanger 205. The preheated fuel-air-water mixture leaves exchanger 205 through a concentric diffuser and is then fed to the ATR 206, which corresponds to process step A of FIG. 1. The diffuser allows even flow distribution at the ATR 206 inlet. The hot hydrogen product from the ATR 206 is collected through a concentric diffuser and routed back to exchanger 205 for heat recovery. In this embodiment, exchanger 205 is mounted directly above the ATR 206 in order to minimize flow path, thereby reducing energy losses and improving overall energy efficiency. Flow conditioning vanes can be inserted at elbows in order to achieve low pressure drop and uniform flow through ATR 206.

The cooled hydrogen product from exchanger 205 is then routed through a concentric diffuser to desulfurization reactor 207, which corresponds to process step C of FIG. 1. The desulfurized product is then fed to catalytic shift reactor 208, which corresponds with process step E in FIG. 1. Cooling coil 209 is provided to control the exothermic shift reaction temperature, which improves carbon monoxide conversion leading to higher efficiency. In this embodiment, cooling coil 209 also preheats ATR 206 feed, further improving heat recovery and fuel cell efficiency. The shift reaction product is then collected through a concentric diffuser and is cooled in spiral exchanger 210, which also preheats water feed W.

Air A is then introduced to the cooled shift reaction product, which is then routed to a concentric diffuser feeding preferred CO oxidation reactor 211. Reactor 211 oxidizes trace carbon monoxide to carbon dioxide, which corresponds to process step G in FIG. 1. Flow conditioning vanes may be inserted at elbows to achieve short flow paths and uniform low pressure drop throughout reactor 211. The effluent purified hydrogen stream is then collected in a concentric diffuser and is sent to exchanger 212 which recovers heat energy into the water feed W. The cooled hydrogen stream is then flashed in separator 213 to remove excess water W. The hydrogen gas stream P from separator 213 is then suitable for hydrogen users, such as a fuel cell.

In the embodiment described in FIG. 2, the combined anode and cathode vent gas streams from a fuel cell are introduced to fuel processor 200 for heat recovery from the unconverted hydrogen in the fuel cell. Integration of the fuel cell with the fuel processor considerably improves the overall efficiency of electricity generation from the fuel cell. The fuel cell tail gas T flows through a concentric diffuser to ATO 214. Hydrogen, and possibly a slip stream of methane and other light hydrocarbons are catalytically oxidized according to:

CH₄+2O₂->CO₂+2H₂O (VII)

H₂+½O₂->H₂O (VIII)

Equations VII and VIII take place in ATO 214, which can be a fixed bed reactor composed of catalyst pellets on beads, or preferably a monolithic structured catalyst. The hot reactor effluent is collected through a concentric diffuser and is routed to exchanger 203 for heat recovery with the combined fuel/air mixture from reactor 202. Heat from the fuel cell tail gas stream T is then further recovered in exchanger 201 before being flashed in separator 215. The separated water is connected to the processor effluent water stream W and the vent gas is then vented to the atmosphere.

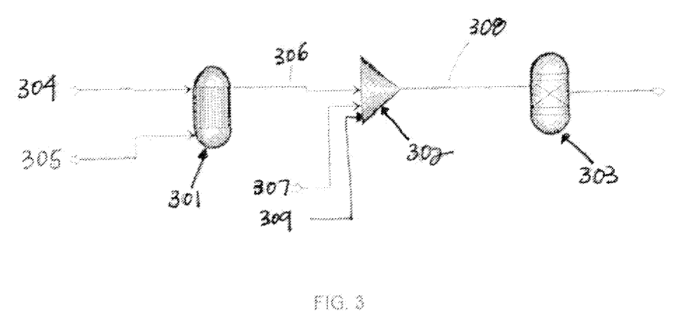

With reference to FIG. 3, FIG. 3 illustrates one embodiment of a catalyst preburner 301 used in fuel processing applications. The catalyst preburner 301 is positioned upstream of the catalyst burner 303. A mixer 302 is positioned downstream of the catalyst preburner 301 and upstream of the catalyst burner 303. In a preferred embodiment, the catalyst burner 303 is an ATO. A gas fuel mixture 304, along with a primary air flow 305, is fed to the catalyst preburner 301. The catalyst preburner 301 produces a catalyst preburner exhaust 306 which is fed, along with a secondary air flow 307, to the mixer 302. In addition, anode tailgas from a fuel cell or off-gas from a pressure swing adsorption unit 309 may also be fed to the mixed 302. Only supplement fuel (natural gas or liquid fuel) and primary air are fed to the preburner. Secondary air, preburner exhaust, anode tailgas, or off-gas from a pressure swing adsorption unit may be fed to the mixer.

The gas fuel mixture 304 fed to the catalyst preburner 301 may be a fuel such as natural gas; but may include other gas fuels as well, such as butane, propane, or the like. When natural gas is used, an oxygen to carbon ratio between 0-1 is needed and 0.3-0.7 is preferred (corresponding air flow is between 0-4.8 moles of air per mole of natural gas). A preferred example is an oxygen to carbon ratio of 0.5 (2.4 moles of air per mole of natural gas). Without the use of a catalyst preburner 301, an oxygen to carbon ratio of 7 would be required (33.3 moles of air per mole of natural gas). This primary air flow 305 is easier to heat because the flow rate is much smaller (2.4 compared to 33.3) and/or the temperature of the bed of the catalyst preburner 301 is easier to keep hot. In addition, the space velocity for the catalyst preburner 301 is smaller than for an ATO 303 which results in good fuel conversion. Further, when the total flow into the catalyst burner 303 is smaller, the heat exchange between gas and bed is reduced too and it will be easier to keep the catalyst bed of the catalyst burner 303 hot.

In the above illustration, FIG. 3, a liquid fuel such as liquefied petroleum gas (LPG), gasoline, diesel, jet fuel, methanol, ethanol, or the like may be used instead of natural gas as the gas fuel mixture 304 entering the catalyst preburner 301. When a liquid fuel is used, a liquid fuel vaporizer would be required.

The catalyst preburner 301 can be pellet packed or monolith. Partial oxidation catalysts such as Platinum (Pt), Palladium (Pd), or Ruthenium (Ru) can be used.

The following table presents the result of an Aspen Plus® simulation for streams of molar fraction, flow and temperature.

| | Catalyst | | |
|---|---|---|---|
| | Preburner | Mixer | |
| | Exhaust | Exhaust | ATO Exhaust |
| CH₄ | 3.07 | 0.37 | 0.00 |
| O₂ | 0.00 | 18.45 | 14.98 |
| N₂ | 40.89 | 74.38 | 76.85 |
| H₂ | 35.62 | 4.32 | 0.00 |
| CO | 17.37 | 2.11 | 0.00 |
| CO₂ | 1.31 | 0.16 | 2.72 |
| H₂O | 1.74 | 0.21 | 5.45 |
| Total Flow (kmol/hr) | 4.60 | 37.93 | 36.71 |
| Temperature (° C.) | 711.1 | 118.2 | 745.4 |

While the methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A method for using a catalyst preburner in fuel processing applications comprising:
providing said catalyst preburner upstream of a catalyst burner, wherein said catalyst preburner produces a catalyst preburner exhaust;
providing a mixer downstream of said catalyst preburner and upstream of said catalyst burner, wherein said mixer produces a mixer exhaust;
feeding a gas mixture with a primary air flow to said catalyst preburner;
feeding said catalyst preburner exhaust with a secondary air flow to said mixer; and
feeding said mixer exhaust to said catalyst burner.

2. The method of claim 1, wherein said catalyst burner is an anode tailgas oxidizer.

3. The method of claim 1, wherein said catalyst preburner, said mixer, and said catalyst burner are integrated into a single unit.

4. The method of claim 3, wherein said single unit is a cylinder can.

5. The method of claim 1, wherein said gas mixture comprises natural gas.

6. The method of claim 5, wherein oxygen to carbon ratio for said catalyst preburner is between 0 and 1.

7. The method of claim 6, wherein said oxygen to carbon ratio is 0.5.

8. The method of claim 5, wherein said primary air flow is between 0 and 4.8 moles per 1 mole of said natural gas.

9. The method of claim 8, wherein said primary air flow is 2.4 moles per 1 mole of said natural gas.

10. The method of claim 1, wherein said gas mixture comprises propane.

11. The method of claim 1, wherein said gas mixture comprises a liquid fuel.

12. The method of claim 11, wherein said liquid fuel is liquefied petroleum gas.

13. The method of claim 11, wherein said liquid fuel is gasoline.

14. The method of claim 11, wherein said liquid fuel is diesel.

15. The method of claim 11, wherein said liquid fuel is jet fuel.

16. The method of claim 11, wherein said liquid fuel is methanol.

17. The method of claim 11, wherein said liquid fuel is ethanol.
